(19) United States
(12) Patent Application Publication
(10) Pub. No.: US 2026/0142198 A1
(43) Pub. Date: May 21, 2026

(54) FUEL ELECTRODE FOR HYDROGEN FUEL CELL USING Pt AND/OR Pd CATALYST AND METHOD FOR MANUFACTURING SAME

(71) Applicant: KOREA INSTITUTE OF SCIENCE AND TECHNOLOGY, Seoul (KR)

(72) Inventors: Sungeun YANG, Seoul (KR); Ji-Won Son, Seoul (KR); Jiho Hong, Seoul (KR); Kyung Joong Yoon, Seoul (KR); Jong Ho Lee, Seoul (KR); Ho-Il JI, Seoul (KR); Deok-Hwang Kwon, Seoul (KR); Hye Jung Chang, Seoul (KR); Byung Kook Kim, Seoul (KR)

(21) Appl. No.: 19/175,693

(22) Filed: Apr. 10, 2025

(30) Foreign Application Priority Data
Nov. 18, 2024 (KR) 10-2024-0164236

(51) Int. Cl. H01M 4/92; H01M 4/86; H01M 4/88; H01M 8/12

(52) U.S. Cl. CPC H01M 4/925; H01M 4/8657; H01M 4/8663; H01M 4/8875; H01M 4/8885; H01M 2008/1293

(57) ABSTRACT

A fuel electrode for a hydrogen fuel cell according to an embodiment of the present invention includes a fuel electrode support layer and a fuel electrode functional layer positioned on the fuel electrode support layer, in which the fuel electrode functional layer includes gadolinium-doped ceria with one or more catalysts selected from Pt and Pd supported thereon.

### CROSS-REFERENCE TO RELATED APPLICATION

This application claims priority to and the benefit of Korean Patent Application No. 10-2024-0164236 filed with the Korean Intellectual Property Office on Nov. 18, 2024, the entire contents of which are incorporated herein by reference.

### BACKGROUND OF THE INVENTION

### (a) Field of the Invention

An embodiment of the present invention relates to a fuel electrode for a hydrogen fuel cell using a Pt and/or Pd catalyst and a method for manufacturing the same.

### (b) Description of the Related Art

As the importance of environmental protection and sustainable energy resources is being highlighted worldwide, research on clean energy sources that can replace fossil fuels is actively being conducted. In particular, hydrogen fuel cells are attracting attention due to their high energy efficiency and eco-friendly characteristics.

A solid oxide fuel cell (SOFC), which is a type of hydrogen fuel cell, is becoming a major means of energy generation due to its excellent performance at high operating temperatures and flexibility enabling a variety of fuels to be used. However, nickel (Ni), a fuel electrode material of existing SOFCs, can cause performance degradation and durability issues due to agglomeration that occurs during the fuel conversion process.

### SUMMARY OF THE INVENTION

An embodiment of the present invention attempts to provide a fuel electrode for a hydrogen fuel cell using a Pt and/or Pd catalyst and a method for manufacturing the same. Specifically, the present invention provides a fuel electrode for a hydrogen fuel cell having improved performance by supporting a Pt and/or Pd catalyst on gadolinium-doped ceria (GDC) and a method for manufacturing the same.

A fuel electrode for a hydrogen fuel cell according to an embodiment of the present invention includes a fuel electrode support layer and a fuel electrode functional layer positioned on the fuel electrode support layer, in which the fuel electrode functional layer includes ceria doped with gadolinium, on which one or more catalysts selected from Pt and Pd are supported.

The catalyst may be supported in the fuel electrode functional layer in an amount of 0.1 to 0.5 atomic %.

The catalyst may be dispersed within the fuel electrode functional layer with an average particle diameter of 0.2 to 5 nm.

The gadolinium may be included in the fuel electrode functional layer in an amount of 1 to 10 atomic %.

The ceria may be included in the fuel electrode functional layer in an amount of 89.9 to 98.5 atomic %.

A method for manufacturing a fuel electrode for a hydrogen fuel cell according to an embodiment of the present invention includes: mixing a catalyst powder including one or more selected from a Pt powder and a Pd powder with a gadolinium-doped ceria powder to manufacture a mixed powder; compressing the mixed powder to manufacture a shaped body; heat-treating the shaped body; and forming a fuel electrode functional layer on a fuel electrode support layer using the heat-treated shaped body as a raw material.

In the manufacturing the mixed powder, the catalyst powder may be mixed in an amount of 0.01 to 0.5 atomic % with respect to 100 atomic % of the mixed powder.

A pressure applied to the mixed powder in the manufacturing the shaped body may be 100 to 500 MPa.

In the heat-treating, a temperature may be increased at a heating rate of 50 to 150° C./h, and the heat-treating may be performed at a temperature of 1000 to 1600° C.

A hydrogen fuel cell according to an embodiment of the present invention includes the fuel electrode including the fuel electrode support layer and fuel electrode functional layer described above, an electrolyte layer positioned on the fuel electrode functional layer, and an air electrode positioned on the electrolyte layer.

According to an embodiment of the present invention, the performance of a hydrogen fuel cell is improved while minimizing the amount of catalyst.

According to an embodiment of the present invention, the catalyst is evenly distributed within the fuel electrode functional layer to maximize reactivity.

### BRIEF DESCRIPTION OF THE DRAWINGS

FIG. 1 is a flowchart schematically showing a sequence of a method for manufacturing a fuel electrode according to an embodiment of the present invention.

FIG. 2 is a schematic diagram schematically showing a cross-section of a hydrogen fuel cell according to an embodiment of the present invention.

FIGS. 3 and 4 are electron micrographs of a fuel electrode functional layer prepared in Example 1, analyzed using transmission electron microscopy (TEM) and energy dispersive X-ray spectroscopy (EDS).

FIGS. 5 and 6 are electron micrographs of a fuel electrode functional layer prepared in Example 2, analyzed using transmission electron microscopy (TEM) and energy dispersive X-ray spectroscopy (EDS).

FIG. 7 is a graph showing results of analyzing the fuel electrode functional layer prepared in Example 1 using X-ray photoelectron spectroscopy (XPS).

FIG. 8 is a graph showing results of analyzing the fuel electrode functional layer prepared in Example 2 using X-ray photoelectron spectroscopy (XPS).

FIG. 9 is a graph showing results of a performance test of a hydrogen fuel cell in Experimental Example 3.

### DETAILED DESCRIPTION OF THE EMBODIMENTS

The technical terms used herein are set forth only to mention specific embodiments and are not intended to limit the present invention. Singular forms used herein are intended to include the plural forms as long as phrases do not clearly indicate an opposite meaning. In the present specification, the term “including (comprising)” is intended to embody specific characteristics, regions, integers, steps, operations, elements and/or components, but is not intended to exclude presence or addition of other characteristics, regions, integers, steps, operations, elements, and/or components.

Unless otherwise defined, all terms including technical and scientific terms used herein have the same meanings as the meanings generally understood by one skilled in the art to which the present invention pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

The terms such as first, second and third are used for describing, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present invention.

In addition, unless otherwise specifically stated, % means mol %, and if no unit is specified separately, a unit based on mol is omitted.

In the present specification, the term “combination(s) thereof” included in the expression of the Markush format means one or more mixtures or combinations selected from the group consisting of the constituent elements described in the expression of the Markush format, and means including one or more selected from the group consisting of the constituent elements.

Hereinafter, embodiments of the present invention will be described in detail. However, the embodiments are only provided by way of example, and the present invention is not limited thereto, but is only defined by the scope of the claims described later.

A fuel electrode 10 of a hydrogen fuel cell 100 according to an embodiment of the present invention includes a fuel electrode support layer 12 and a fuel electrode functional layer 11 positioned on the fuel electrode support layer 12.

The fuel electrode functional layer 11 includes gadolinium-doped ceria with one or more catalysts selected from Pt and Pd supported thereon.

In an embodiment of the present invention, the catalyst includes one or more selected from Pt and Pd. Among other metal catalysts, platinum (Pt) and palladium (Pd) are excellent in improving the performance and durability of the fuel electrode 10. The catalyst may be supported in an amount of 0.1 to 0.5 atomic % within the fuel electrode functional layer 11. If too little catalyst is supported, it is difficult to sufficiently achieve the performance improvement of the fuel electrode 10 through the catalyst. If too much catalyst is supported, the catalysts may agglomerate, which can rather deteriorate performance. More specifically, the catalyst may be supported in an amount of 0.2 to 0.4 atomic % within the fuel electrode functional layer 11. When Pt and Pd are included simultaneously, the ratio can be calculated based on their contents.

The catalyst may be dispersed within the fuel electrode functional layer 11 with an average particle diameter of 0.2 to 10 nm. If the catalyst is dispersed with an excessively large average particle diameter, it is difficult to sufficiently achieve performance improvement by the catalyst. The average particle diameter may be obtained by analyzing the fuel electrode functional layer 11 using energy dispersive X-ray spectroscopy (EDS) or the like, obtaining a virtual circle having the same area as the appearing catalyst particles, and then calculating a diameter of the circle. The average particle diameter refers to an arithmetic mean particle diameter. More specifically, the catalyst may have an average particle diameter of 1 to 8 nm.

Gadolinium-doped ceria is represented as Gd_{0.1}Ce_{0.9}O_{1.95} (GDC), and this material is ceria-based and is inherently reactive. In addition, in an embodiment of the present invention, the reactivity is further promoted by the catalyst.

Gadolinium (Gd) may be included in an amount of 1 to 10 atomic % in the fuel electrode functional layer 11. If too little gadolinium is included, it is difficult to sufficiently achieve the reactivity-promoting effect. If too much gadolinium is included, it may cause problems such as a reduction in phase stability or a decline in electrode performance. More specifically, gadolinium (Gd) may be included in an amount of 3 to 8 atomic % in the fuel electrode functional layer 11.

Ceria is the remainder other than the aforementioned catalyst and gadolinium and may be included in an amount of 89.9 to 98.5 atomic % in the fuel electrode functional layer 11.

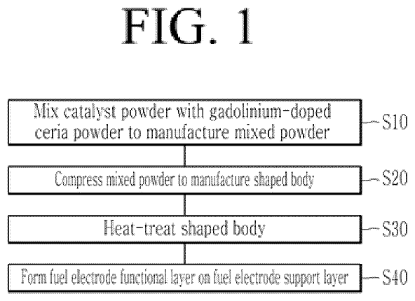

FIG. 1 shows a flow chart of a method for manufacturing a fuel electrode for a hydrogen fuel cell according to an embodiment of the present invention.

As shown in FIG. 1, a method for manufacturing the fuel electrode 10 for the hydrogen fuel cell 100 according to an embodiment of the present invention includes a step S10 of mixing a catalyst powder including one or more selected from a Pt powder and a Pd powder with a gadolinium-doped ceria powder to manufacture a mixed powder; a step S20 of compressing the mixed powder to manufacture a shaped body; a step S30 of heat-treating the shaped body; and a step S40 of forming a fuel electrode functional layer on a fuel electrode support layer using the heat-treated shaped body as a raw material.

Below, each step will be described in detail.

First, in step S10, a catalyst powder including one or more selected from Pt powder and Pd powder is mixed with a gadolinium-doped ceria powder to manufacture a mixed powder.

Since the catalyst powder and the gadolinium-doped ceria powder are the same as described above, the redundant description will be omitted. In this case, the catalyst powder may be mixed in an amount of 0.1 to 0.5 atomic % with respect to 100 atomic % of the mixed powder.

The mixing method is not particularly limited, but a ball mill may be used.

Next, in step S20, the mixed powder is compressed to manufacture a shaped body. The compressed shape is not particularly limited, and the mixed powder may be compressed into a cylindrical shape, for example.

A pressure applied to the mixed powder may be 100 to 500 MPa. If the pressure is too low, the shape may not be appropriately maintained. If the pressure is too high, problems may arise where the shape is not maintained or defects occur inside a generated phase. More specifically, the pressure applied to the mixed powder may be 150 to 300 MPa.

Next, in step S30, the shaped body is heat treated.

A temperature may be increased at a heating rate of 50 to 150° C./h, and the heat treatment may be performed at a temperature of 1000 to 1600° C. The shaped body is uniformly sintered through an appropriate heating rate and heat treatment temperature to produce a pellet with mechanical strength. More specifically, the temperature may be increased at a heating rate of 70 to 130° C./h, and the heat treatment may be performed at a temperature of 1200 to 1500° C.

Next, in step S40, a fuel electrode functional layer is formed on a fuel electrode support layer using the heat-treated shaped body as a raw material. Specifically, the heat-treated shaped body may be used as a target to form the fuel electrode functional layer 11 on the fuel electrode support layer 12. Pulsed laser deposition (PLD) may be used as a deposition method.

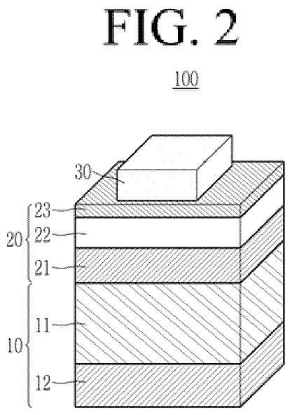

FIG. 2 schematically illustrates a cross-section of the hydrogen fuel cell 100 according to an embodiment of the present invention. As shown in FIG. 2, the hydrogen fuel cell 100 according to an embodiment of the present invention includes the fuel electrode 10 including the fuel electrode support layer 12 and fuel electrode functional layer 11, an electrolyte layer 20 positioned on the fuel electrode functional layer, and an air electrode 30 positioned on the electrolyte layer 20.

Since the fuel electrode 10 has been described above, a detailed description will be omitted. Hydrogen is injected into the fuel electrode 10.

The electrolyte layer 20 may include a first GDC layer 21 including gadolinium-doped ceria, a YSZ layer 22 positioned on the first GDC layer 21 and including yttria-stabilized zirconia, and a second GDC layer 23 positioned on the YSZ layer 22 and including gadolinium-doped ceria. The composition of the electrolyte layer may be composed of ceria-based electrolytes, zirconia-based electrolytes, or the like used in general SOFCs without limitation. Specifically, the first GDC layer 21, the YSZ layer 22, and the second GDC layer 23 may be deposited using a PLD (Pulsed Laser Deposition) method.

The air electrode 30 may include lanthanum strontium cobalt oxide (LSC). The air electrode 30 may be deposited using a PLD method. Oxygen is injected into the air electrode 30. For the components of the air electrode, the lanthanum strontium-based air electrodes and various air electrodes used in general SOFCs may be selected and used.

Hereinafter, examples of the present invention will be described in detail. However, the Examples are only provided by way of example, and the present invention is not limited thereto, but is only defined by the scope of the claims described later.

### Example 1: Preparation of 0.3Pt-GDC Fuel Electrode

Pt powder was measured to be 0.3 atomic % of the total powder and added together with GDC powder, which was then mixed evenly by ball milling.

The powder was shaped into a wide cylindrical form through pelletizing, subjected to a uniaxial press with a certain load, and then compressed at a pressure of approximately 200 MPa using a cold isostatic press.

Thereafter, the temperature was increased to 1400° C. at a heating rate of 100° C./h and heat treatment was performed for 1 hour at 1400° C., resulting in formation of a target pellet for preparing a fuel electrode functional layer.

The heat-treated shaped body was deposited on a fuel electrode support layer using the pulsed laser deposition method at a substrate temperature of 700° C. in a 200 mTorr O₂ atmosphere for 1 hour and 15 minutes, resulting in preparation of a fuel electrode functional layer.

### Example 2: Preparation of 0.3Pd-GDC Fuel Electrode

The same manner as in Example 1 was performed except that Pd powder was added instead of Pt powder in an amount of 0.3 atomic %.

### Comparative Example 1: Preparation of GDC Fuel Electrode

The same manner as in Example 1 was performed without adding Pt powder.

### Experimental Example 1: TEM and EDS Analyses

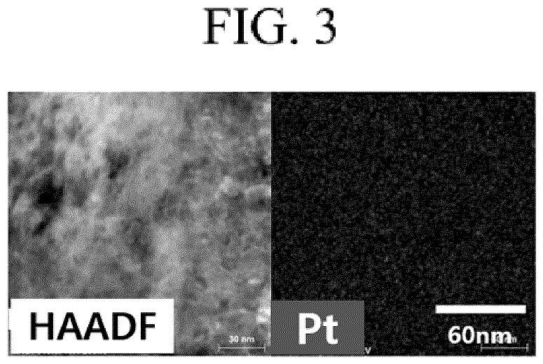

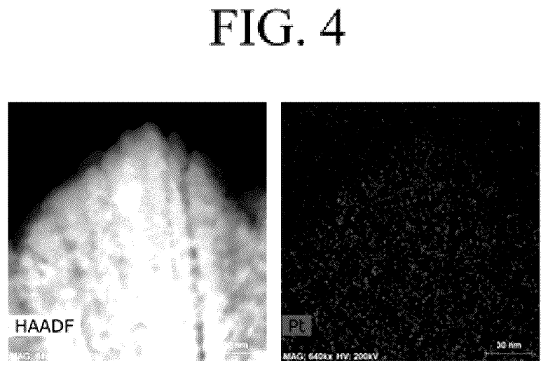

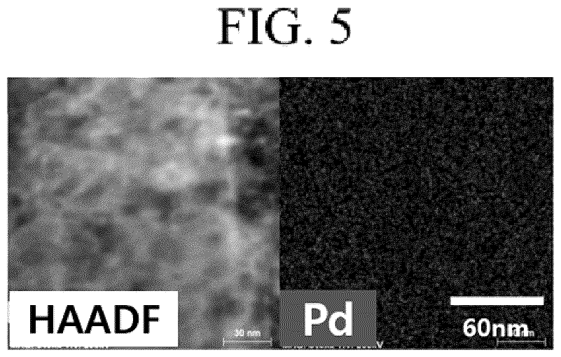

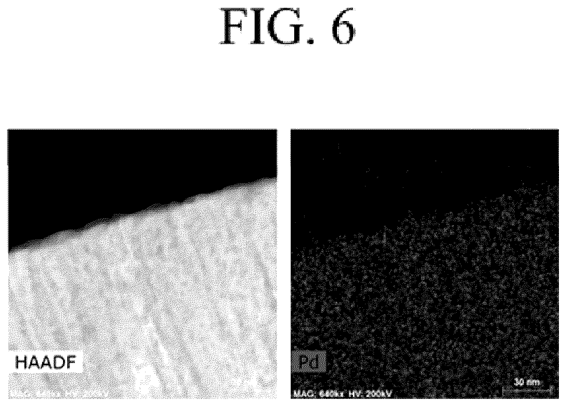

The fuel electrodes prepared in Examples 1 and 2 were analyzed using transmission electron microscopy (TEM) and energy dispersive X-ray spectroscopy (EDS), and the results are shown in FIGS. 3 to 6.

It was confirmed that the fuel electrode functional layer prepared in Example 1 contained about 0.38 atomic % of Pt, about 5.9 atomic % of Gd, and the remainder of ceria.

It was confirmed that the fuel electrode functional layer prepared in Example 2 contained about 0.24 atomic % of Pd, about 5.03 atomic % of Gd, and the remainder of ceria.

In addition, as shown in FIGS. 3 to 6, it can be confirmed that each of Pt and Pd is dispersed uniformly to several nanometers.

### Experimental Example 2: Analysis Using X-Ray Photoelectron Spectroscopy (XPS)

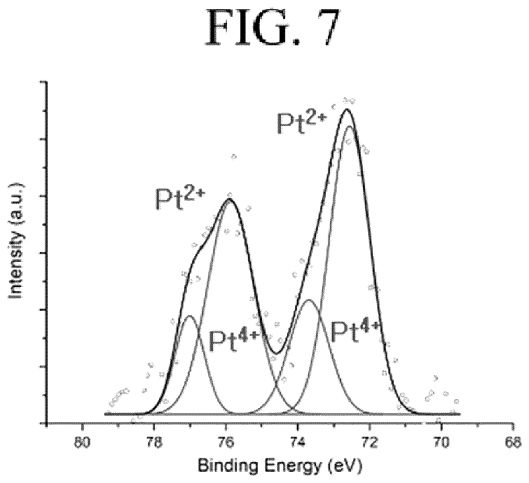

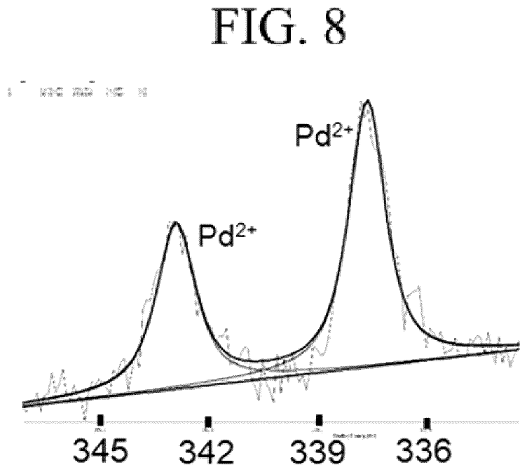

The fuel electrodes prepared in Examples 1 and 2 were reduced in a 4% H₂/Ar atmosphere at 600° C. for 2 hours, after which the catalysts were analyzed by X-ray photoelectron spectroscopy (XPS), and the results are shown in FIGS. 7 and 8.

As shown in FIGS. 7 and 8, it can be confirmed that most of Pt and Pd catalysts exist in the form of monatomic species or other forms as 2+ or 4+ ions, with a trace amount of metallic species present.

### Experimental Example 3: Performance Test of Hydrogen Fuel Cell

A three-layered electrolyte having a GDC-YSZ-GDC structure was fabricated on each of the fuel electrode functional layers prepared in Example 1, Example 2, and Comparative Example 1. Using a GDC target as the first layer, deposition was performed by PLD in a 50 mTorr O₂ atmosphere at a fuel electrode temperature of 700° C. for 25 minutes. Thereafter, using a YSZ target as the second layer, deposition was performed by PLD in a 50 mTorr O₂ atmosphere at a fuel electrode temperature of 700° C. for 20 minutes. Using a GDC target as the third layer, deposition was performed by PLD in a 50 mTorr O₂ atmosphere at a fuel electrode temperature of 700° C. for 5 minutes.

For the fabrication of the air electrode at the top, using an LSC target, deposition was performed by PLD in a 300 mTorr O₂ atmosphere at a substrate temperature of 680° C. for 2 hours.

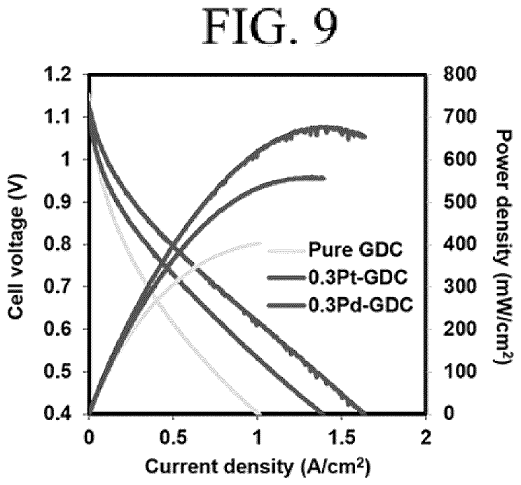

The test conditions were set such that at a temperature of 500° C., the fuel electrode was supplied with 3% wet H₂ at a flow rate of 200 sccm, and the air electrode was supplied with air at a flow rate of 200 sccm. The results are shown in FIG. 9.

As shown in FIG. 9, it can be confirmed that Example 1 (0.3Pt-GDC) and Example 2 (0.3Pd-GDC) have improved performance compared to Comparative Example 1 (Pure GDC).

It can be confirmed that, between Examples 1 and 2, Example 1 exhibits the best performance.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

| | |
|---|---|
| 100: hydrogen fuel cell | 10: fuel electrode |
| 11: fuel electrode functional layer | 12: fuel electrode support layer |
| 20: electrolyte layer | 21: first GDC layer |
| 22: YSZ layer | 23: second GDC layer, |
| 30: air electrode | |

What is claimed is:

1. A fuel electrode for a hydrogen fuel cell, comprising:
a fuel electrode support layer; and
a fuel electrode functional layer positioned on the fuel electrode support layer, wherein,
the fuel electrode functional layer comprises ceria doped with gadolinium, on which one or more catalysts selected from Pt and Pd are supported.

2. The fuel electrode for a hydrogen fuel cell of claim 1, wherein:
the catalyst is supported in the fuel electrode functional layer in an amount of 0.1 to 0.5 atomic %.

3. The fuel electrode for a hydrogen fuel cell of claim 1, wherein:
the catalyst is dispersed within the fuel electrode functional layer with an average particle diameter of 0.2 to 5 nm.

4. The fuel electrode for a hydrogen fuel cell of claim 1, wherein:
the gadolinium is included in the fuel electrode functional layer in an amount of 1 to 10 atomic %.

5. The fuel electrode for a hydrogen fuel cell of claim 1, wherein:
the ceria is included in the fuel electrode functional layer in an amount of 89.9 to 98.5 atomic %.

6. A method for manufacturing a fuel electrode for a hydrogen fuel cell, the method comprising:
mixing a catalyst powder comprising one or more selected from a Pt powder and a Pd powder with a gadolinium-doped ceria powder to manufacture a mixed powder;
compressing the mixed powder to manufacture a shaped body;
heat-treating the shaped body; and
forming a fuel electrode functional layer on a fuel electrode support layer using the heat-treated shaped body as a raw material.

7. The method of claim 6, wherein:
in the manufacturing the mixed powder, the catalyst powder is mixed in an amount of 0.1 to 0.5 atomic % with respect to 100 atomic % of the mixed powder.

8. The method of claim 6, wherein:
a pressure applied to the mixed powder in the manufacturing the shaped body is 100 to 500 MPa.

9. The method of claim 6, wherein:
in the heat-treating, a temperature is increased at a heating rate of 50 to 150° C./h, and the heat-treating is performed at a temperature of 1000 to 1600° C.

10. A hydrogen fuel cell comprising:
the fuel electrode comprising the fuel electrode support layer and fuel electrode functional layer of claim 1;
an electrolyte layer positioned on the fuel electrode functional layer; and
an air electrode positioned on the electrolyte layer.
